(19) United States
(12) Patent Application Publication
(10) Pub. No.: US 2008/0297105 A1
(43) Pub. Date: Dec. 4, 2008

(54) POLARITY ADJUSTING APPARATUS FOR CHARGING CIRCUIT

(75) Inventor: MING-CHIH HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/869,756

(22) Filed: Oct. 10, 2007

(30) Foreign Application Priority Data
Jun. 1, 2007 (CN) 200710200746.7

(51) Int. Cl. H02J 7/00

(52) U.S. Cl. 320/107

(57) ABSTRACT

A polarity adjusting apparatus for automatically adjusting polarity of a connection between a power supply and a charging circuit includes first˜fourth diodes, first and second input terminals configured for connecting to positive and negative terminals of the power supply, and first and second output terminals configured for respectively connecting to positive and negative input terminals of the charging circuit. The anode and cathode of the first diode are respectively connected to the first input terminal and the first output terminal. The anode and cathode of the second diode are respectively connected to the second input terminal and the first output terminal. The cathode and anode of the third diode are respectively connected to the first input terminal and the second output terminal. The cathode and anode of the fourth diode are respectively connected to the second input terminal and the second output terminal.

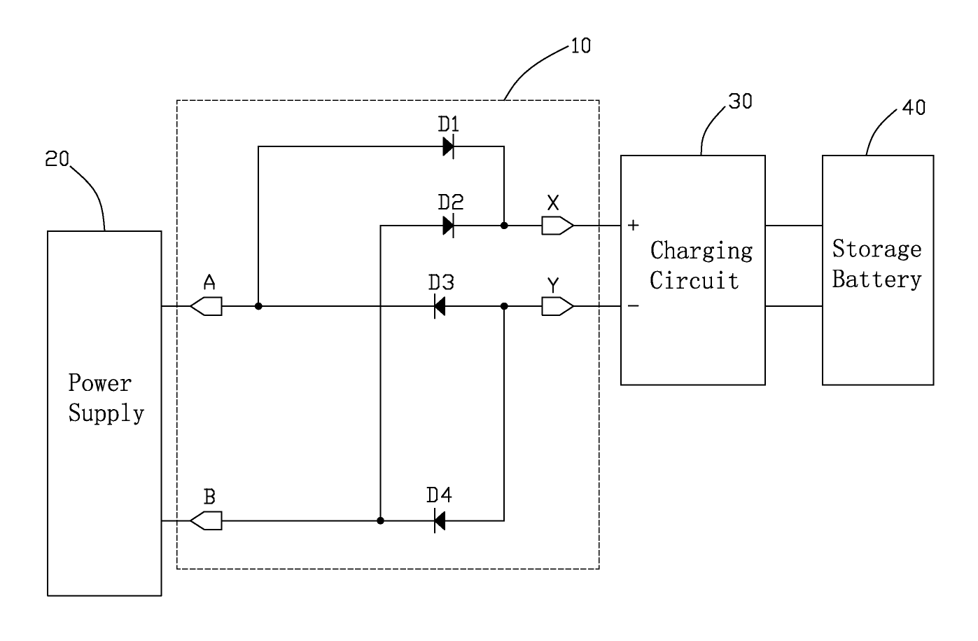

### BACKGROUND

1. Field of the Invention

The present invention relates to adjusting apparatuses, and particularly to a polarity adjusting apparatus for automatically adjusting polarity of a connection between a power supply and a charging circuit.

2. Description of Related Art

Generally speaking, a conventional charging circuit has a positive input terminal and a negative input terminal respectively connected to a positive terminal and a negative terminal of a power supply for receiving power from the power supply, and then charges a storage battery.

However, users may connect the positive and negative input terminals of the charging circuit to the negative and positive terminals of the power supply respectively by mistake sometimes, which may damage the charging circuit or the storage battery.

What is desired, therefore, is to provide a polarity adjusting apparatus which can automatically adjust polarity of a connection between a power supply and a charging circuit.

### SUMMARY

An embodiment of a polarity adjusting apparatus for automatically adjusting polarity of a connection between a power supply and a charging circuit includes first˜fourth diodes, first and second input terminals configured for connecting to positive and negative terminals of the power supply, and first and second output terminals configured for respectively connecting to positive and negative input terminals of the charging circuit. The anode and cathode of the first diode are respectively connected to the first input terminal and the first output terminal. The anode and cathode of the second diode are respectively connected to the second input terminal and the first output terminal. The cathode and anode of the third diode are respectively connected to the first input terminal and the second output terminal. The cathode and anode of the fourth diode are respectively connected to the second input terminal and the second output terminal.

Other advantages and novel features of the present invention will become more apparent from the following detailed description of an embodiment when taken in conjunction with the accompanying drawing, in which:

### BRIEF DESCRIPTION OF THE DRAWING

The drawing is a circuit diagram of a power supply connected to a charging circuit via a polarity adjusting apparatus in accordance with an embodiment of the present invention.

### DETAILED DESCRIPTION

Referring to the drawing, a polarity adjusting apparatus 10 in accordance with an embodiment of the present invention includes a first diode D1, a second diode D2, a third diode D3, a fourth diode D4, two input terminals A and B configured for connecting to a positive terminal and a negative terminal of a power supply 20, and two output terminals X and Y configured for respectively connecting to a positive input terminal + and a negative input terminal − of a charging circuit 30. The charging circuit 30 receives power from the power supply 20 via the polarity adjusting apparatus 10 to charge a storage battery 40.

The anode of the first diode D1 is connected to the input terminal A. The cathode of the first diode D1 is connected to the output terminal X. The anode of the second diode D2 is connected to the input terminal B. The cathode of the second diode D2 is connected to the output terminal X. The cathode of the third diode D3 is connected to the input terminal A. The anode of the third diode D3 is connected to the output terminal Y. The cathode of the fourth diode D4 is connected to the input terminal B. The anode of the fourth diode D4 is connected to the output terminal Y.

When the charging circuit 30 charges the storage battery 40, the input terminals A and B are connected to the positive and negative terminals of the power supply 20, and the output terminals X and Y are respectively connected to the positive input terminal + and the negative input terminal − of the charging circuit 30. If polarity connection is correct, namely the positive and negative terminals of the power supply 20 are respectively connected to the input terminals A and B of the polarity adjusting apparatus 10, the first diode D1 and fourth diode D4 are turned on, the second diode D2 and third diode D3 are turned off. Thereby, the charging circuit 30 can correctly receive power from the power supply 20. If polarity connection is wrong, namely the positive and negative terminals of the power supply 20 are respectively connected to the input terminals B and A of the polarity adjusting apparatus 10, the first diode D1 and fourth diode D4 are turned off, the second diode D2 and third diode D3 are turned on. Thereby, the charging circuit 30 also can correctly receive power from the power supply 20.

The polarity adjusting apparatus 10 can automatically adjust polarity of the connection between the power supply 20 and the charging circuit 30, which can avoid damaging the charging circuit 30 and the storage battery 20 when the wrong polarity connection happens.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A polarity adjusting apparatus for automatically adjusting polarity of a connection between a power supply and a charging circuit, the power supply comprising a positive terminal and a negative terminal, the charging circuit comprising a positive input terminal and a negative input terminal, the polarity adjusting apparatus comprising:
a first input terminal configured to connect with any one of the positive terminal and the negative terminal;
a second input terminal configured to connect with the remained one of the positive terminal and the negative terminal;
a first output terminal and a second output terminal configured for respectively connecting to the positive input terminal and the negative input terminal of the charging circuit;
a first diode, the anode of the first diode connected to the first input terminal and the cathode of the first diode connected to the first output terminal;
a second diode, the anode of the second diode connected to the second input terminal and the cathode of the second diode connected to the first output terminal;
a third diode, the cathode of the third diode connected to the first input terminal and the anode of the third diode connected to the second output terminal; and
a fourth diode, the cathode of the fourth diode connected to the second input terminal and the anode of the fourth diode connected to the second output terminal.
